(19) United States
(12) Patent Application Publication
(10) Pub. No.: US 2008/0035552 A1
(43) Pub. Date: Feb. 14, 2008

(54) MULTI-FUNCTION AND MULTI-LAYER FILTRATION DEVICE

(76) Inventor: Hsiung-Che Lee, Kaohsiung City (TW)

Correspondence Address: LEONG C LEI, PMB # 1008, 1867 YGNACIO VALLEY ROAD, WALNUT CREEK, CA, 94598, US

(21) Appl. No.: 11/383,962

(22) Filed: May 18, 2006

(51) Int. Cl. B01D 29/00

(52) U.S. Cl. 210/335; 210/501; 210/502.1; 210/446

(57) ABSTRACT

The filtration device mainly contains a hollow body member having a water inlet and a water outlet at two ends; a number of open-top container members vertically stacked and reliably positioned, inside the body member; and a number of agent members placed inside the container members respectively. Each of the container members has a number of through holes arranged spirally at the bottom so that the water is forced into a swirl as it flows through the container members to make full utilization of the agent members. The body member is sealed by a cover that can be easily twisted close or open. As such, the standardized container members can be easily accessed and the agent members can be easily replaced.

### BACKGROUND OF THE INVENTION

(a) Technical Field of the Invention

The present invention generally relates to filtration devices, and more particularly to a filtration device having multiple vertically stacked, container inside, each of which contains a particular type of filtering agent.

(b) Description of the Prior Art

Various water filtration or purification devices are widely popular recently as people become more concerned about the quality of the water they drink and use. However, most of the water filtration device or purification devices are single-purposed. For example, a reverse osmosis water purifier is usually installed at the kitchen faucet for filtering tap water; it cannot be used to filter the cultivation water of an aquarium device. As such, there are various types of filtration or purification devices and a user has to purchase and install different types of filtration or purification devices, each for a specific demand of the user. This is obviously a costly approach.

Therefore, R.O.C (Taiwan) Patent No. M276,613 discloses a multilayer filtration device having a hollow body whose inner chamber has gradually decreasing diameter from top to bottom. A number of planar filtering members containing filtering cotton are positioned cross-sectionally in the chamfer and various filtering agents such as far-infrared fine ceramic particles, high-purity copper-zinc alloy (i.e., KDF), calcium sulfite, active carbon, etc., are confined between any two vertically adjacent filtering members respectively. By placing appropriate filtering agents inside the chamber, the filtration device can be adapted for a specific water filtration purpose.

However, the foregoing prior art has a number of disadvantages. First the body with inner chamber of decreasing diameter is more difficult to manufacture, contributing to a higher production cost. Secondly, the installation of the filtering members inside the chamber, especially those near the bottom of the body, is difficult and usually requires some special toot to make them to be truly horizontally positioned, again contributing to higher production cost. Thirdly, the body is permanently sealed so that the filtering agents cannot be replaced when, their functionality degrades after a period of usage. As such, the entire filtration device has to be replaced altogether, which is not environmental friendly and economical. In addition, the body is usually sealed by fusing a cover to the body. The fusing interface between the cover and the body sometimes would burst when it cannot withstand the higher water pressure inside. The higher water pressure would also deform and displace the filtering members, and the filtering agents therefore would escape from the confinement of the filtering members and mix/react wife each other, destroying their filtering function.

### SUMMARY OF THE INVENTION

The primary purpose of the present invention is to provide a filtration, device to obviate the foregoing shortcomings of prior arts. The filtration device mainly contains a hollow body member having a water inlet and a water outlet at two ends; a number of open-top container members vertically stacked and reliably positioned inside the body member; and a number of agent members placed inside the container members respectively.

Each of the container members has a number of through holes arranged spirally at the bottom so that when the water is introduced into the body member via the water inlet, the water is forced into a swirl as it flows through the container members layer by layer to make full utilization, of the agent member inside each container member.

The body member is sealed by a cover that can be easily twisted close or open. As suck the standardized container members can be easily accessed and the agent members can be easily replaced. By placing appropriate agent members inside the container members, the filtration device can be specialized to fulfill a specific filtration requirement; without purchasing a totally different filtration device and/or abandoning the existing one.

The foregoing object and summary provide only a brief introduction to the present invention. To folly appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded diagram showing the various components of a filtration device according to a first embodiment of the present invention.

FIG. 2 is a schematic sectional diagram showing the filtration device of FIG. 1 after its assembly.

FIG. 3 is a schematic sectional diagram showing the water flow through the filtration device of FIG. 1.

FIG. 4 is a schematic sectional diagram showing a filtration device according to a second embodiment of the present invention.

FIG. 5 is a schematic sectional diagram showing a filtration device according to a third embodiment of the present, invention.

FIG. 6 is a perspective diagram showing another embodiment of the container member of the present invention.

FIG. 7 is a schematic sectional diagram showing the container member of FIG. 6.

FIG. 8 is a perspective diagram showing yet another embodiment of the container member of the present invention.

FIG. 9 is a schematic diagram showing an application of the present invention in the kitchen.

FIG. 10 is a schematic diagram showing an application of the present invention in the bathroom.

### DETAILED DESCRIPTION OF THE PREFERRED EMBODIMENTS

The following descriptions are of exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention, as set forth in the appended claims.

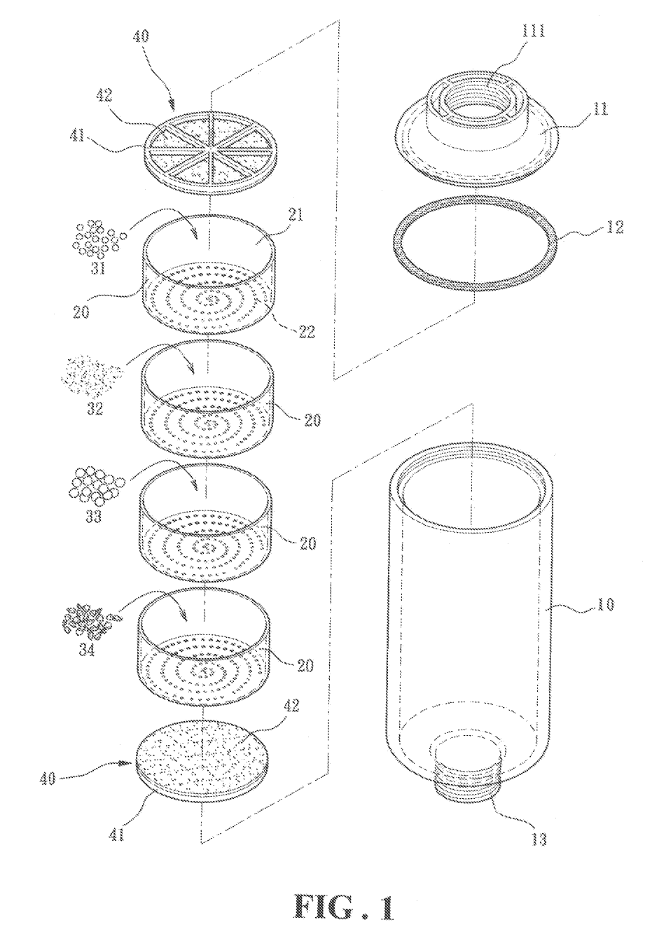

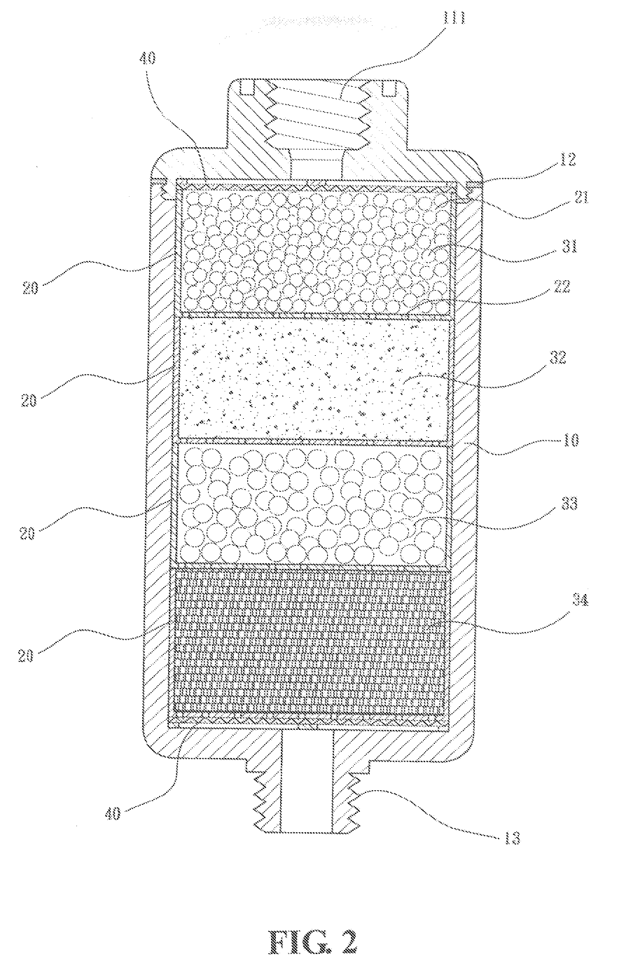

As illustrated in FIGS. 1 and 2, an embodiment of the present invention contains a hollow body member 10 having a water inlet 111 at a top end and a water outlet 13 at a bottom end; a number of open-top container members 20 vertically stacked inside the body member 10; and a number of agent members 31, 32, 33, and 34 placed inside the container members 20 respectively. The water inlet can be connected to the bath, or kitchen faucet or the tap of a reverse osmosis (RO) water purifier so as to introduce water into the present invention for filtration.

The body member 10 has a cover 11 at the top end which is twisted to the body member or joined to the body member by a similar mechanism. A ring washer 12 is provided between the cover 11 and the body member 10 to prevent water leakage. The cover 11 as such can be easily opened for a user to access the interior space of the body member 10 for maintenance. The water inlet 111 is provided in the center of the cover 11 and has a tubular shape with threads configured on the inner wall. On the other hand at the bottom end of the body member 10, the water outlet 13 also has a tubular shape but with threads configured on the outer wall.

The container members 20 are identically shaped with a diameter slightly smaller than that of the body member 10 so that an appropriate number of the container members 20 can be vertically stacked and reliably positioned, inside the body member 10 (in the present embodiment, four container members 20 are shown). Each container member 20 provides a storage space 21 inside and a number of through holes 22 spirally arranged from, the center at the bottom of the container member 20. As such, the water is forced to flow through the container member 20 in a swirl.

The agent members 31, 32, 33, and 34 can be made by one the following materials including far-infrared fine ceramic particles, high-purity copper-zinc alloy (KDF), calcium sulfite, active carbon, or similar material with water filtration function. Appropriate amounts of the agent members 31, 32, 33, and 34 are placed inside the storage spaces 21 of the container members 20 respectively:

The present embodiment also contains two filtering members 40 positioned on top of the topmost container member 20 and beneath the bottommost container member 20 respectively. The present embodiment is designed such that, when the body member 10 is sealed by its cover 11, the top filtering member 40, the stacked container members 20, and the bottom filtering member 40 are tightly joined together. As such, the filtering member 40 on the top securely covers the open top of the topmost container member 20 so that the agent member 31 inside wouldn't escape from the storage space 21. Similarly, the rest of the container members 20 are also securely and tightly stacked so that their respective agent members 32, 33, and 34 wouldn't escape and mix with, other agent members. The filtering members 40 also provide additional filtration effect. Each of the filtering members 40 contains a planar frame 41 enclosing a layer of filtering cotton.

The various components of the present embodiment are all made of material conforming to the strict standards of food and drug authorities so that they all share common properties such as resistant to high temperature, non-toxic, anti-crash, etc.

After assembly, water is introduced to the present embodiment from the water inlet 111, filtered through the agent members 31, 32, 33, 34 of the container members 20 sequentially, and then the filtered water is supplied through the water outlet 13.

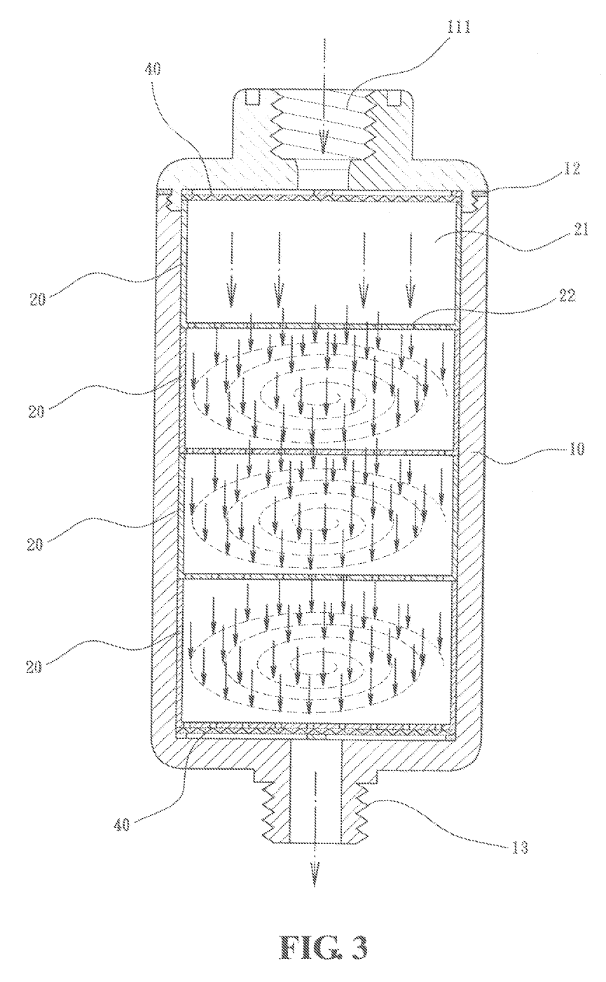

The present invention provides a number of advantages, which can be seen from FIG. 3. As illustrated, the various components of the present invention have very simple shapes and therefore can be manufactured with very low cost. The present invention is also designed such that, when the container members 20 are placed inside the body member 10 one by one, they are securely held together without resorting to any special tools. The body member 10 can be easily opened or closed by the cover 11 and replacing any one of the agent members 31, 32, 33, and 34 can be easily and separately accomplished without throwing away those agent: members that are still functional. The spiral-patterned through holes 22 force the water flowing through into a swirl so as to make full utilization of the agent member in the storage space 21.

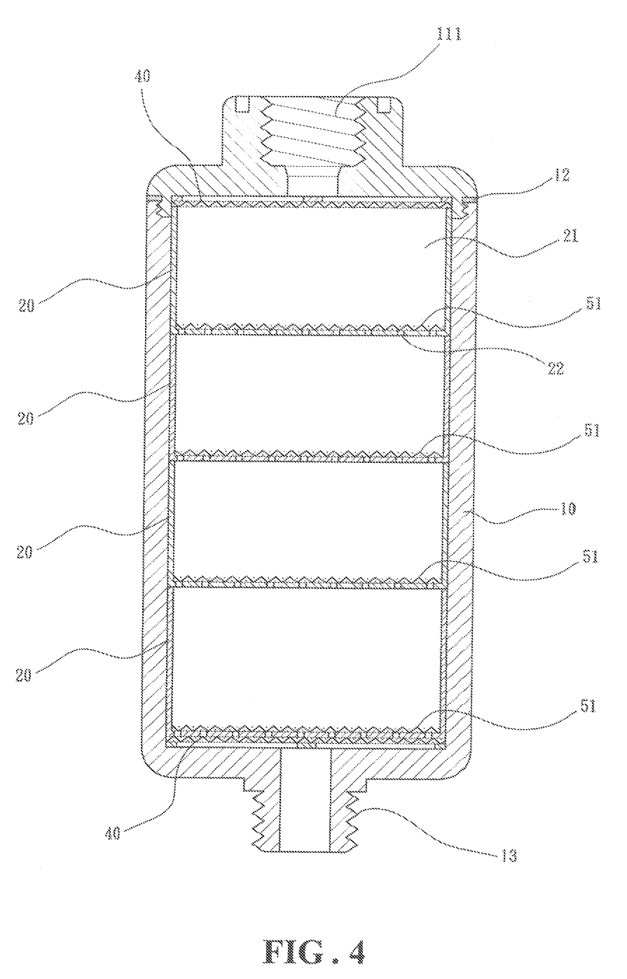

As shown in FIG. 4, a layer of filtering cotton 51 can be disposed to tightly cover the entire bottom, of each, container member 20, so as to enhance the filtering performance.

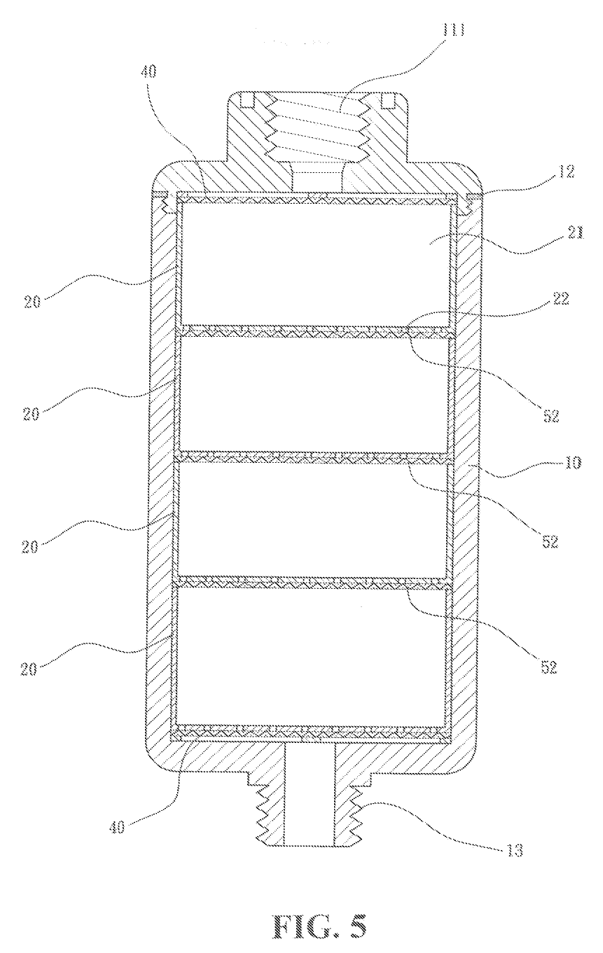

Additionally, as shown in FIG. 5, another layer of filtering cotton 52 can be interposed between any two vertically adjacent container members 20 and is fixedly positioned there by the wall and the bottom surface of the two container members 20. Similarly, the layer of filtering cotton 52 can also be disposed between the topmost container member 20 and the top filtering member 40, and between the bottommost container member 20 and the bottom filtering member 40.

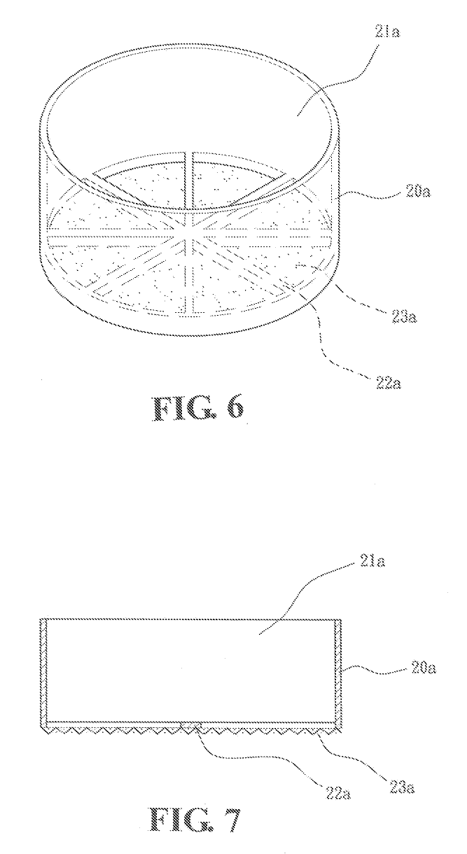

Another embodiment of the container member is illustrated in FIGS. 6 and 7. As shown, the container member 20a has an opened top with storage space 21a. The bottom of the container member 20a has a planar frame 22a so as to confine a layer of filtering cotton 23a therewithin for enhanced filtering performance.

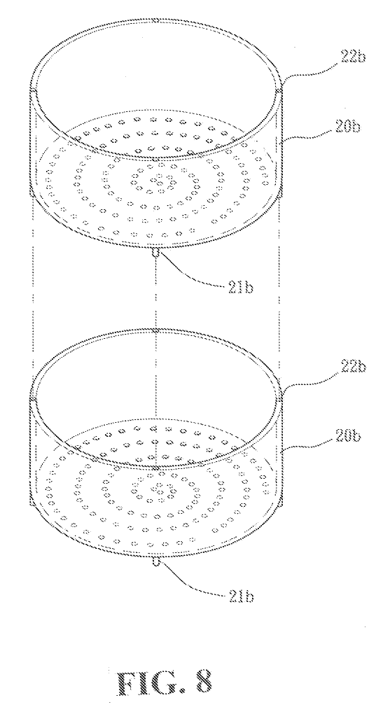

Yet another embodiment of the container member is illustrated in FIG. 8. As shown, each of the container members 20b has a number of notches 22b along the top surface of the wail, and a number of stubs 21b along the circumference of the bottom surface. When the container members 20b are stacked, the stubs 21b of a container member 20b can be embedded and locked to the notches 22b of the container member 20b beneath. Please note that the filtering members 40 ran have the same type of locking mechanism so as to be joined, to the stack of container members 20b as described. With the locking mechanism, the container members 20b can be stacked and joined together and men installed into or removed from the body member 10 altogether, making the assembly/disassembly of the present invention even simpler.

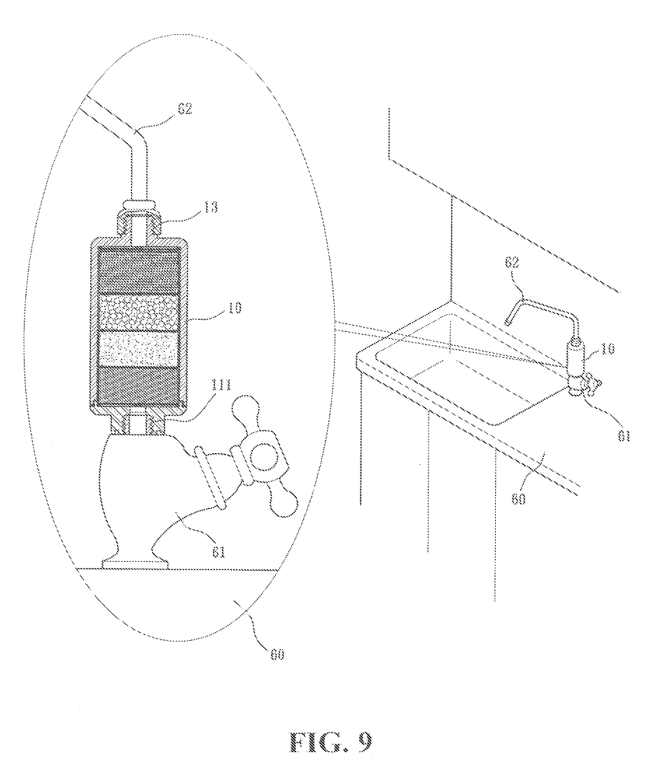

As shown in FIG. 9, in an application scenario of the present invention, the water inlet 111 of the body member 10 is joined to a kitchen faucet 61 on the kitchen sink 60 by the inner thread of the water inlet 111. On the other hand, a water sprout 62 is joined to the water outlet 13 by its outer threads. As such, tap water is filtered by the present invention for healthy and safe drinking and cooking.

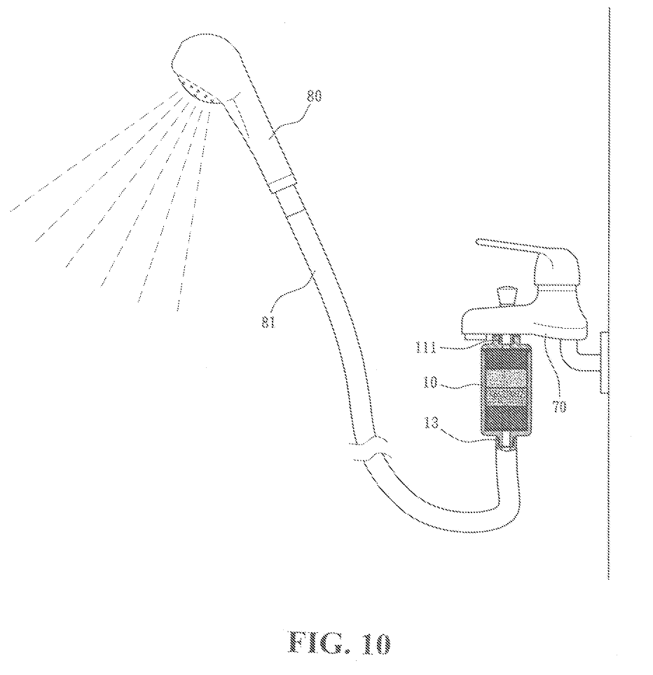

As shown in FIG. 10, in another application scenario of the present invention, the water inlet 111 of the body member 10 is joined to a shower faucet 70 in the bathroom by the inner thread of the water inlet 111. On the other hand, a shower head 80 at an end of a pipe 81 is joined to the water outlet 13 by fixing the other end of the pipe 81 to the outer threads of the water outlet 13. As such, water is filtered by the present invention before it is used for shower and bath.

Similarly, the present invention can be connected to basically any water supply sources such as, just to name a few, a reverse osmosis water purifier for additional filtration, or an aquarium device to filter the fish droppings and unconsumed feed left in the water.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will he understood that various omissions, modifications, substitutions and changes in the forms and details of the device illustrated and in its operation can be made by those skilled in the art without departing in any way from the spirit of the present invention.

I claim:

1. A filtration device, comprising:
a hollow body member having a water inlet and a water outlet at two ends;
a plurality of container members, each having a plurality of through holes at the bottom, vertically stacked inside said body member and between said water inlet and outlet; and
a plurality of agent members placed inside said container members respectively.

2. The filtration device according to claim 1, wherein said through holes of each said container member are arranged in a spiral pattern.

3. The filtration, device according to claim 1, wherein a layer of filtering cotton is placed on the bottom surface of each said container member.

4. The filtration device according to claim 1, wherein a layer of filtering cotton is interposed between any two vertically adjacent said container members.

5. The filtration device according to claim 1, wherein a plurality of notches are provided along the top surface of the wall of each said container member; a plurality of stubs are provided along the circumference on the bottom surface of each said container member; and said stubs of a first, container member are embedded and locked to said notches of a second container member stacked beneath said first container member.

6. The filtration device according to claim 1, wherein a removable cover is provided at one of said two end of said body member so as to seal said body member and to allow access into the interior space of said body member.

7. The filtration device according to claim 1, wherein said, water inlet has a tubular shape with threads along the inner wall of said water inlet; and said water outlet has a tubular shape with threads along the outer wail of said water outlet.

8. The filtration device according to claim 1, wherein each said agent member is made of one of the materials: far-infrared ceramic particles, copper-zinc alloy, calcium sulfite, and active carbon.

9. The filtration device according to claim 1, wherein a filtering member is provided on top of the topmost said container member; a filtering member is provided beneath, the bottommost said container member; and each said filtering member comprises a frame and filtering cotton.

10. A filtration device, comprising:
a hollow body member having a water inlet and a water outlet at two ends;
a plurality of container members, each having a frame at the bottom, with a layer of filtering cotton confined in said frame, vertically stacked inside said body member and between said water inlet and outlet; and
a plurality of agent members placed inside said container members respectively.
